(19) United States
(12) Patent Application Publication
(10) Pub. No.: US 2025/0138749 A1
(43) Pub. Date: May 1, 2025

(54) DATA COLLECTION AND STORAGE DURING LOW-POWER STATES

(71) Applicants: ATI TECHNOLOGIES ULC, Markham (CA); ADVANCED MICRO DEVICES, INC., Santa Clara, CA (US)

(72) Inventors: I-Cheng Chen, Markham (CA); Pankaj Sen, Bangalore (IN)

(21) Appl. No.: 18/385,117

(22) Filed: Oct. 30, 2023

(51) Int. Cl. G06F 3/06; G06F 1/3234; G06F 1/3296

(52) U.S. Cl. CPC G06F 3/0656; G06F 1/3275; G06F 1/3296; G06F 3/0625; G06F 3/0679

(57) ABSTRACT

A processing system includes one or more sensors configured to generate sensor data while a memory of the processing system is in a low-power state. As the sensors generate the sensor data, the sensor data is stored in a buffer. The processing system further includes a sensor data management circuitry that tracks a usage of the buffer. Based on the usage of the buffer exceeding a threshold, the sensor data management circuitry is configured to wake at least a portion of the memory from the low-power state. Once the memory exits the low-power state, the processing system transfers the sensor data from the buffer to one or more locations within the memory. After writing the sensor data to the memory, the processing system then places at least a portion of the memory back in the low-power state.

### BACKGROUND

Some processing systems, such as those implemented in mobile devices, are configured to reduce power consumption by placing certain elements of the processing system in low-power states. While in a lower-power state, elements of the processing system are configured to perform fewer operations and actions, helping to reduce the power consumption of these elements. To place these elements in low-power states, some processing systems include a system management controller that is configured to control various signals connected to the elements. By controlling these signals, the system management controller is configured to induce a low-power power state in an element of the processing system using clock gating techniques or power gating techniques, respectively.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram illustrating a processing system configured for sensor data collection and storage during low-power memory states, in accordance with some implementations.

FIG. 2 is a flow diagram illustrating an example operation for sensor data collection and storage during a low-power memory state, in accordance with some implementations.

FIG. 3 is a timing diagram illustrating buffer usage during a first power state and a second power state of a memory, in accordance with some implementations.

FIG. 4 is a flow diagram illustrating an example method for combining sensor data collection and storage based on memory power states, in accordance with some implementations.

### DETAILED DESCRIPTION

Some processing systems, such as those in mobile devices, smartphones, gaming systems, laptops, wearable devices, and the like, are configured to help conserve power by placing portions of one or more components of the processing system in one or more low-power states. These low-power states, for example, include placing at least a portion of a component in an idle state, an off state, a self-refresh state, or any combination thereof such that the component draws less power than when in a normal power state (e.g., on state, active state, operating state). Portions of such components placed into a low-power state include portions of central processing units (CPUs), acceleration units (AUS), memories, security processors, or any combination thereof, to name a few. To place a portion of a component in a certain power state (e.g., regular power state, low-power state), some processing systems include a system management circuitry (e.g., a system management controller) configured to send a state signal so as to place a component in a certain power state. These state signals, for example, each include data indicating a certain power state in which to place one or more portions of the component. For example, a state signal includes data indicating a clock frequency to provide to a component so as to place at least a portion of that component in a certain power state. As another example, a state signal includes data indicating a voltage, current, power, or any combination thereof to provide to a component so as to place at least a portion of the component in a certain power state. In response to receiving a clock signal or power signal based on such a state signal, one or more portions of the component then enter the power state indicated by the state signal.

Further, to help improve user experience, some processing systems include a sensor circuitry that includes one or more sensors configured to collect data (e.g., take measurements) regarding a device including the processing system, a user of the processing system (e.g., a user of the device), or both. As an example, the sensors collect data representative of user interactions with a device such as a user handling the device, a user moving the device, a user looking at a camera of the device, a user making noise (e.g., speaking) around the device, or any combination thereof, to name a few. The data collected by the sensor is then used by applications executed by the processing system such that the applications take certain actions based on the user interactions represented by the sensor data. To help execute these applications, debug the processing system (e.g., applications, sensors), or both, the sensor circuitry is configured to store the data collected by the sensors (e.g., store the measurements taken by the sensors) in one or more buffers of the sensor circuitry. The processing system then transfers the sensor data from the buffers into the system memory.

However, when the system memory is in a low-power state, the processing system is unable to transfer the sensor data from the buffers of the sensor circuitry to the system memory. To this end, systems and techniques disclosed herein include a processing system configured to collect and store sensor data while the system memory is in a low-power state. The processing system includes a system management circuitry (e.g., a system management controller) configured to place one or more portions of one or more components of the processing system in one or more power states. As an example, the system management circuitry is configured to place the system memory in a low-power state, such as a self-refresh state. While the system memory is in a low-power state, one or more sensors of a sensor circuitry take one or more measurements so as to generate sensor data. Such sensor data, for example, includes one or more measurements representative of a user interaction with a device including the processing system. As the sensors generate the sensor data, the sensor circuitry is configured to store the sensor data in a buffer included in or otherwise connected to the sensor circuitry.

Further, the processing system includes a sensor data management circuitry configured to monitor the usage of the buffer storing the sensor data. Such a usage, for example, represents a percentage of the buffer being used to store the sensor data. The sensor data management circuitry is further configured to determine whether the buffer has reached a threshold usage by comparing the monitored usage to a predetermined threshold value. Based on the monitored usage of the buffer being equal to or greater than the predetermined threshold value, the sensor data management circuitry generates a wake-up signal and sends the wake-up signal to the system management circuitry. Such a wake-up signal, for example, includes data indicating that the buffer has reached the threshold usage, data indicating a portion of the system management circuitry is to enter a regular power state, or both. Based on receiving the wake-up signal, the system management circuitry wakes up at least a portion of the system memory and generates a transfer signal that includes, for example, an instruction to transfer data. As an example, based on receiving the wake-up signal, a portion of the system management circuitry exits a low-power state (e.g., enters a regular power state) and generates one or more state signals so as to have a memory controller, at least a portion of the system memory, or both exit a low-power state (e.g., enter a regular power state). The system management circuitry then generates and provides a transfer data signal to a memory controller associated with the system memory. The transfer data signal, for example, includes data indicating that the sensor data is to be written from the buffer of the sensor circuitry to one or more locations (e.g., memory addresses) in the system memory. Based on receiving the transfer sensor data signal, the memory controller then transfers the sensor data from the buffer of the sensor circuitry to the system memory. For example, the memory controller writes the sensor data to an area of the system memory indicated in the transfer sensor data signal.

Once the memory controller has transferred the data from the buffer to the system memory, the system management circuitry generates one or more state signals so as to have the memory controller, at least a portion of the system memory, or both return to a low-power state. The sensors then continue to take measurements and the sensor data management circuitry continues to monitor the buffer until the threshold usage is again met. As the threshold usage is again met, the sensor data management circuitry again wakes up the system management circuitry and, subsequently, the memory controller and system memory so as to transfer the data in the buffer. In this way, the processing system is configured to collect and store sensor data in the system memory while the system memory is in a low-power state. Namely, the processing system is configured to only wake up the system memory to store the sensor data when the buffer is at a threshold usage, helping to reduce the amount of time the system memory is placed in a regular power state and helping to limit the power consumption needed to transfer sensor data in the system memory. Further, because the system memory is placed back in a low-power state after the sensor data is written from the buffer to the system memory, the system memory is only in a regular power state during the data transfer, again helping to reduce the amount of time the system memory is placed in a regular power state and helping to limit the power consumption needed to store sensor data in the system memory.

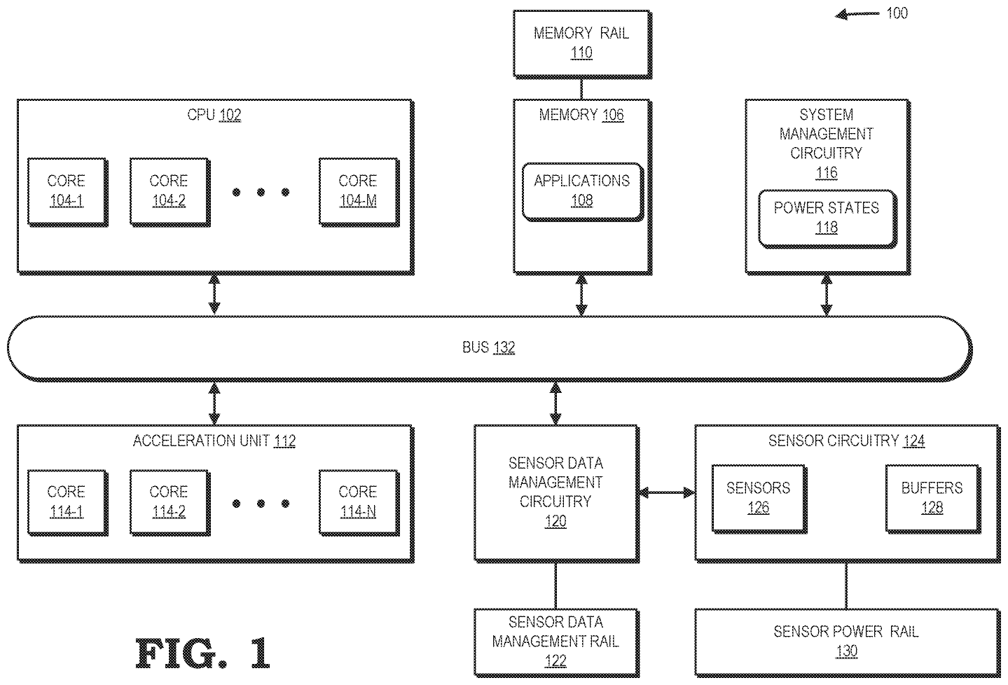

FIG. 1 is a block diagram of a processing system 100 configured to collect and store sensor data in system memory while the system memory is in a low-power memory state, in accordance with some implementations. According to some implementations, processing system 100 is implemented in a mobile device powered by one or more batteries (not pictured for clarity). For example, in some implementations, processing system 100 is implemented in a smartphone, gaming system, laptop, automotive system, drone, wearable device, or the like. In implementations, processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 132 to support communication between components (e.g., CPU 102, AU 112, memory 106, system management circuitry 116, sensor data management circuitry 120, sensor circuitry 124) implemented in the processing system 100. Some implementations of the processing system 100 include other buses, bridges, switches, routers, and the like, which are not shown in FIG. 1 in the interest of clarity. For example, in some implementations, processing system 100 includes a data fabric including bus 132 and configured to support communication between the components of processing system 100.

According to implementations, processing system 100 is configured to execute one or more applications 108. Such applications 108, for example, include compute applications, graphics applications, or both. A compute application, when executed by processing system 100 causes processing system 100 to perform one or more computations, for example, machine-learning computations, neural network computations, databasing computations, or the like. A graphics application, when executed by processing system 100, causes processing system 100 to render a scene including one or more graphics objects within a screen space and, for example, display them on a display (not pictured for clarity). To help execute one or more applications 108, processing system 100 includes AU 112. AU 112, for example, includes one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. In implementations, AU 112 performs one or more commands, instructions, draw calls, or any combination thereof indicated in an application 108. For example, AU 112 performs one or more commands, instructions, draw calls, or any combination thereof so as to render images according to one or more graphics applications for presentation on a display. To this end, as an example, AU 112 renders graphics objects (e.g., groups of primitives) to produce values of pixels that are provided to a display which uses the pixel values to display an image that represents the rendered graphics objects.

To perform commands, instructions, draw calls, or any combination thereof for an application 108, AU 112 includes a number of processor cores 114 each operating as one or more compute units. According to implementations, processor cores 114 each operating as one or more compute units are configured to execute instructions, commands, and draw calls concurrently or in parallel. To this end, in some implementations, one or more processor cores 114 each operating one or more compute units include SIMD units that perform the same operation on different data sets. As an example, one or more processor cores 114 each includes SIMD units that perform the same operation as indicated by one or more commands, instructions, or both from an application 108. According to implementations, after performing one or more operations for an application 108, a SIMD unit stores the data resulting from the performance of the operation (e.g., the results) in a cache connected to an associated processor core 114, memory 106, or both. Though in the example implementation illustrated in FIG. 1, three processor cores (114-1, 114-2, 114-N) are presented representing an N number of processor cores, the number of processor cores 114 implemented in AU 112 is a matter of design choice. As such, in other implementations, AU 112 can include any number of processor cores 114.

Processing system 100 also includes CPU 102 that is connected to the bus 132 and therefore communicates with AU 112 and the memory 106 via the bus 132. CPU 102 implements a plurality of processor cores 104-1 to 104-N that execute instructions concurrently or in parallel. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. In some implementations, the CPU 102 and AU 112 have an equal number of processor cores 104, 114 while in other implementations, CPU 102 and AU 112 have a different number of processor cores 104, 114. The processor cores 104 execute instructions such as program code for one or more applications 108 stored in the memory 106, and CPU 102 stores information in a cache, memory 106, or both such as the results of the executed instructions. In some implementations, CPU 102 is configured to control the data movement between sensor data management circuitry 120, system management circuitry 110, and memory 108 during one or more power states 118. As an example, CPU 102 is configured to generate one or more instructions that, when executed by sensor data management circuitry 120, system management circuitry 110, or a memory controller, cause data to be transferred between sensor data management circuitry 120, system management circuitry 110, and memory 108.

According to implementations, one or more components of processing system 100 are each powered by respective power rails. For example, in the implementation presented in FIG. 1, memory 106 is powered by memory rail 110, sensor data management circuitry 120 is powered by sensor data management rail 122, and sensor circuitry 124 is powered by sensor rail 130. Though the example implementation presented in FIG. 1 shows processing system 100 having three power rails (memory rail 110, sensor data management rail 122, sensor power rail 130) each powering one component of processing system 100, in other implementations, processing system 100 can include any number of power rails each powering any number of components. In implementations, each power rail is configured to provide a respective voltage, current, power, or any combination thereof to one or more components. For example, a first power rail (e.g., memory rail 110) is configured to provide a first voltage to memory 106, and a second power rail (e.g., sensor data management rail 122) is configured to provide a second voltage to sensor data management circuitry 120 wherein the first voltage is different from the second voltage. Because different components of processing system 100 are powered by respective power rails, processing system 100 is configured to control the voltage, current, and power provided to a first component of processing system 100 without affecting the voltage, current, and power provided to a second, different component of processing system 100.

To help reduce the power consumption of processing system 100, processing system 100 includes system management circuitry 116 (e.g., a system management controller) configured to control the power states 118 of one or more components (e.g., CPU 102, memory 106, AU 112, sensor circuitry 124) of processing system 100. Such power states 118, for example, include regular power states (e.g., S0) in which a component is operational (e.g., is configured to perform one or more expected actions) and low-power states in which a component performs fewer actions and consumes less power. As an example, such low-power states include, but are not limited to, self-refresh states, sleep states (e.g., S1, S2, S3, S4, S5), suspended states, idle states, active idle states (e.g., S0I1, S0i3), or any combination thereof. In implementations, system management circuitry 116 is configured to place at least a portion of a component of processing system 100 in a low-power state by generating a low-power state signal. Such a low-power state signal, for example, indicates a frequency to set a clock signal provided to a component so as to place at least a portion of the component in a certain low-power state (e.g., a clock-gated power state) or indicates a voltage, current, or power for a power rail to provide to a component so as to place at a portion of the component in a certain low-power state (e.g., a power-gated power state). Likewise, system management circuitry 116 is configured to have a component exit a low-power state (e.g., place a component in a regular power state) by generating a regular power state signal. Such a regular power state signal, for example, indicates a frequency to set a clock signal provided to a component so as to place at least a portion of the component in a certain regular power state (e.g., an operating state) or indicates a voltage, current, or power for a power rail to provide to a component so as to place at a portion of the component in a certain regular power state.

According to implementations, one or more applications 108 executed by processing system 100 are configured to improve user experience by tracking user interactions with the device (e.g., mobile device) within which processing system 100 is implemented. Such user interactions include, for example, a user handling the device, a user moving the device, a user looking at the device (e.g., a camera of the device), a user making noise (e.g., speaking) around the device, or any combination thereof, to name a few. To track these user interactions, processing circuitry 100 includes sensor circuitry 124. Sensor circuitry 124, for example, includes one or more sensors 126 configured to take one or more measurements representative of a user interaction with a device. As an example, sensor circuitry 124 includes a sensor hub having one or more sensors 126 configured to take one or more measurements of a user, device, or both that represent user interactions with the device. Such sensors 126 include one or more cameras, microphones, accelerometers, temperature sensors, humidity sensors, proximity sensors, gyroscopes, light sensors (e.g., ambient light sensors), global positioning system position sensors, hall sensors, biometric sensors (e.g., fingerprint sensors), magnetometers, or any combination thereof, to name a few. Each sensor 126 is configured to take one or more measurements representative of at least a portion of a user interaction. For example, an accelerometer takes measurements of the acceleration of a device which represents a user moving the device.

After taking one or more measurements, each sensor 126 is configured to store data representing the measurement, also referred to herein as “sensor data,” in one or more buffers 128 included in or otherwise connected to sensor circuitry 124. In implementations, a memory controller included in or otherwise connected to memory 106 (not shown for clarity) is configured to transfer the sensor data from one or more buffers 128 to one or more locations (e.g., physical memory addresses, virtual memory addresses) within memory 106. After the sensor data is transferred to memory 106, one or more applications 108 executed by processing system 100 use the sensor data to determine one or more user interactions with the device including processing system 100 and take one or more actions based on the determined user interactions. Further, in some implementations, the sensor data written to memory 106 is used to debug one or more applications 108, the sensors 126, or both.

Because memory 106 is powered by a first rail (e.g., memory rail 110) and sensor circuitry 124 is powered by a second, different rail (e.g., sensor rail 130), sensor circuitry 124 is enabled to operate while memory 106 is placed in a low-power state. For example, while memory 106 is in a low-power state, sensors 126 are configured to continue taking measurements and storing sensor data in one or more buffers 128. However, when memory 106 is in a low-power state, the memory controller associated with memory 106 cannot transfer the sensor data from the buffers 128 to memory 106. Due to the memory controller not being able to transfer the sensor data to memory 106, the buffers 128 will continue to store sensor data until the buffers 128 are full, causing the buffers to purge sensor data to make room for new sensor data. Such purged sensor data from the buffers 128 negatively affects the ability of applications 108 to detect user interactions, the ability to debug the applications 108 and sensors 126, or both. To this end, power system 100 is configured to have memory 106 exit a low-power state when one or more buffers 128 are at a threshold usage and then transfer the sensor data from the buffers 128 to a location (e.g., physical memory address, virtual memory address) in memory 106. Such a usage, for example, represents a percentage of a buffer 128 currently storing data.

To wake up memory 106 from a low-power state when one or more buffers 128 are at a threshold usage, processing system 100 includes sensor data management circuitry 120. In implementations, sensor data management circuitry 120 is powered by a different power rail (e.g., sensor data management rail 122) than memory 106 and system management circuitry 116. In this way, processing system 100 is configured to place sensor data management circuitry 120 in a regular power state (e.g., operational state) while system management circuitry 116, memory 106, or both are in low-power states. According to implementations, sensor data management circuitry 120 is configured to monitor the usage of one or more buffers 128 of sensor circuitry 124. For example, sensor data management circuitry 120 is configured to determine a usage of one or more buffers 128 and then compare the determined usage to a usage threshold. The usage threshold, for example, includes a predetermined threshold value representing a threshold limit for the usage of one or more buffers 128. Based on the determined usage of a buffer 128 being less than the usage threshold, sensor data management circuitry 120 continues to monitor the usage of the buffer 128. Based on the determined usage of a buffer 128 being equal to or greater than the usage threshold, sensor data management circuitry 120 is configured to place memory 106 in a regular power state (e.g., to have memory 106 exit a low-power state).

To place memory 106 in a regular power state, sensor data management circuitry 120 first sends a signal to system management circuitry 116 indicating that memory 106 is to exit a low-power state. In some implementations, at least a portion of system management circuitry 116 is in a low-power state concurrently with memory 106 being in a low-power state. Based on at least a portion of system management circuitry 116 being in a low-power state, sensor data management circuitry 120 is configured to send a wake-up signal to system management circuitry 116 in response to determining that the usage of a buffer 128 is equal to or greater than a usage threshold. Such a wake-up signal, for example, includes data indicating that at least a portion of system management circuitry 116 (e.g., a security processor) is to be placed in a regular power state and that at least a portion of memory 106 is to be placed in a regular power state. Based on the wake-up signal, at least a portion of system management circuitry 116 (e.g., a security processor) exits a low-power state and then places at least a portion of memory 106 in a regular power state (e.g., has at least a portion of memory 106 exit a low-power state). Further, in some implementations, system management circuitry 116 sends a signal to a memory controller associated with memory 106 indicating that the sensor data in one or more buffers 128 is to be written to one or more certain areas (e.g., physical memory addresses, virtual memory addresses) within memory 106.

After system management circuitry 116 places at least a portion of memory 106 in a regular power state (e.g., operational state), the memory controller associated with memory 106 then transfers the sensor data from one or more buffers 128 to one or more locations within memory 106. Once the memory controller has transferred the sensor data to memory 106, system management circuitry 116 then places memory 106 back into a low-power state. Further, in some implementations, after the memory controller has written the sensor data to memory 106, system management circuitry 116 is configured to place at least a portion of system management circuitry 116 (e.g., a security process) back into a low-power state. Sensor data management circuitry 120 then continues to monitor the usage of one or more buffers 128 and is configured to wake up memory 106 again based on one or more buffers 128 being at a threshold usage. In this way, processing system 100 is configured to collect and store sensor data in memory 106 even while memory 106 is in a low-power state. Because sensor data management circuitry 120 is configured to place memory 106 in a regular power state only when one or more buffers are at a threshold usage, memory 106 is only in the regular power state for a short period of time before returning to a low-power state, helping to reduce the power consumption needed to transfer the sensor data to memory 106.

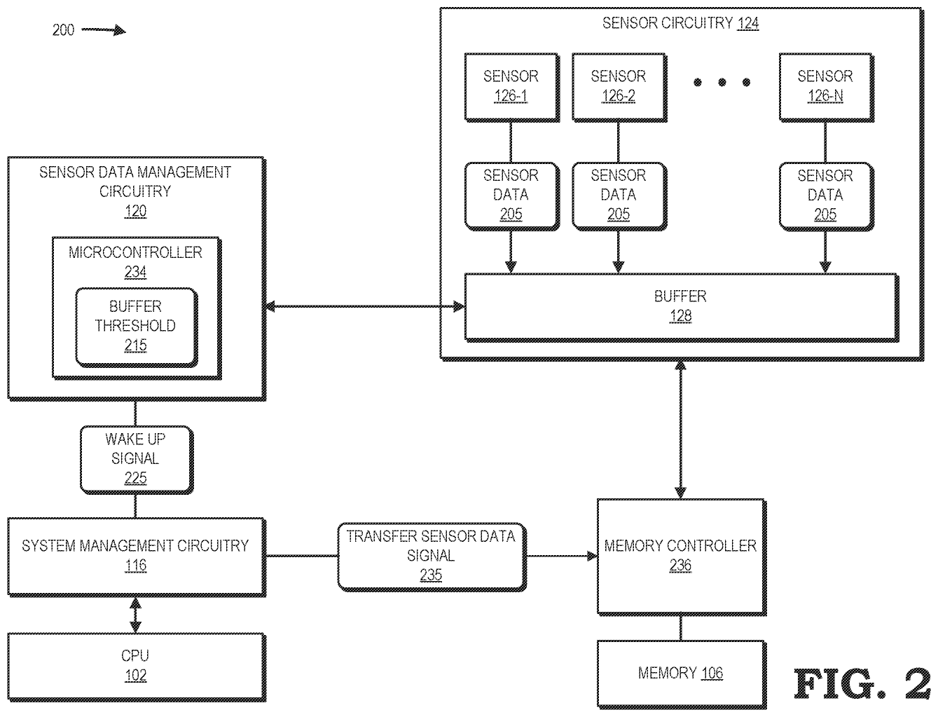

Referring now to FIG. 2, an example operation 200 sensor data collection and storage during a low-power state is presented in accordance with implementations. In implementations, at least a portion of example operation 200 is implemented by sensor data management circuitry 120 while at least a portion of memory 106 is in a low-power state (e.g., a self-refresh state) and at least a portion of system management circuitry 116 is in a low-power state. According to implementations, example operation 200 first includes sensor circuitry 124 generating sensor data 205 while memory 106 is in a low-power state. For example, in implementations, sensor circuitry 124 includes one or more sensors 126 each configured to take one or more measurements of a device including processing system 100, a user of such a device, or both. As an example, each sensor 126 is configured to take one or more measurements of the device, user, or both representative of a user interaction with a device including processing system 100 (e.g., a user handling the device, a user moving the device, a user looking at a camera of the device, a user making noise around the device). To take these measurements, each sensor 126, for example, includes a camera, microphone, accelerometer, temperature sensor, humidity sensor, proximity sensor, gyroscope, light sensor (e.g., ambient light sensor), global positioning system position sensor, hall sensor, biometric sensor (e.g., fingerprint sensor), magnetometer, or any combination thereof. According to implementations, after taking one or more measurements of the device, user, or both, each sensor 126 is configured to store data representing the measurement, represented in FIG. 2 as sensor data 205, in a buffer 128 included in or otherwise connected to sensor circuitry 124. Though the example implementation presented in FIG. 2 shows sensor circuitry 124 including three sensors (126-1, 126-2, 126-N) representing an N number of sensors, in other implementations, sensor circuitry 124 can have any number of sensors 126.

Further, example operation 200 includes sensor data management circuitry 120 monitoring the usage of buffer 128 (e.g., presented as buffers 128 in FIG. 1). That is to say, sensor data management circuitry 120 monitors the percentage of buffer 128 being used to store sensor data 205. To this end, sensor data management circuitry 120 includes one or more microcontrollers 234 configured to monitor buffer 128. These microcontrollers 234 include, for example, one or more AVR microcontrollers, PIC microcontrollers, programmable logic devices (e.g., FPGAs), or any combination thereof. To monitor buffer 128, one or more microcontrollers 234 are configured to determine the usage of buffer 128 (e.g., determine the percentage of buffer 128 being used to store sensor data 205). After determining the usage of buffer 128, the one or more microcontrollers 234 then compare the determined usage to buffer threshold 215. Buffer threshold 215, for example, includes a predetermined value representing a threshold usage (e.g., percentage) of buffer 128. Based on the determined usage of buffer 128 being below buffer threshold 215, the one or more microcontrollers 234 continue to monitor buffer 128 (e.g., continue to determine the usage of buffer 128). Based on the determined usage of buffer 128 being equal to or greater than buffer threshold 215, the one or more microcontrollers 234 begin to wake up memory 106 so as to transfer the sensor data 205 in buffer 128 to memory 106.

To wake up memory 106, in implementations, one or more microcontrollers 234 are configured to generate wake-up signal 225 and provide wake-up signal 225 to system management circuitry 116. Wake-up signal 225, for example, includes data indicating that sensor data 205 from buffer 128 is to be written to memory 106. Further, in implementations, wake-up signal 225 includes data that, when received by system management circuitry 116, causes at least a portion of system management circuitry 116 to exit a low-power state. Based on receiving wake-up signal 225, system management circuitry 116 is configured to have at least a portion of system management circuitry 116 (e.g., a security processor) exit a low-power state and enter a regular power state. After at least a portion of system management circuitry 116 has entered the regular power state, system management circuitry 116 is configured to change memory controller 236 associated with memory 106, at least a portion of memory 106, or both from a low-power state to a regular power state. That is to say, system management circuitry 116 has memory controller 236, at least a portion of memory 106, or both exit a low-power state. To this end, according to some implementations, system management circuitry 116 is configured to generate one or more signals so as to change a clock signal provided to memory controller 236, memory 106, or both; change a voltage, current, or power provided to memory controller 236, memory 106, or both; or a combination of the two. Additionally, after placing memory controller 236, memory 106, or both in a regular power state, system management circuitry 116 is configured to generate and provide a transfer sensor data signal 235 to memory controller 236. Transfer sensor data signal 235, for example, includes data indicating that sensor data 205 from buffer 128 is to be transferred to memory 106, data indicating one or more locations (e.g., physical memory addresses, virtual memory addresses) in memory 106 at which to write sensor data 205, or both.

Based on receiving transfer sensor data signal 235, memory controller 236 then transfers sensor data 205 from buffer 128 to one or more locations in memory 106 indicated by transfer sensor data signal 235. Additionally, in some implementations, memory controller 236 is configured to write one or more timestamps to memory 106 indicating, for example, when a piece of sensor data 205 was generated by a sensor 126, when a piece of sensor data 205 was written to memory 106, or both. According to some implementations, after memory controller 236 transfers sensor data 205 from buffer 128 to memory 106, system management circuitry 116 is configured to place memory controller 236, at least a portion of memory 106, or both back into a low-power state. For example, to place memory controller 236, at least a portion of memory 106, or both back into a low-power state, system management circuitry 116 is configured to generate one or more signals so as to change a clock signal provided to memory controller 236, memory 106, or a both; change a voltage, current, or power provided to memory controller 236, memory 106, or both; or a combination of the two. After placing memory controller 236, at least a portion of memory 106, or both in a low-power state, in some implementations, system management circuitry 116 then places at least a portion of system management circuitry 116 (e.g., a security processor) in a low-power state. Sensor data management circuitry 120 then continues to monitor the usage of buffer 128 until the usage of buffer 128 is equal to or greater than buffer threshold 215. Once the usage of buffer 128 is equal to or greater than buffer threshold 215, sensor data management circuitry 120 then wakes up at least a portion of memory 106 in order to transfer sensor data 205 from buffer 128 to memory 106.

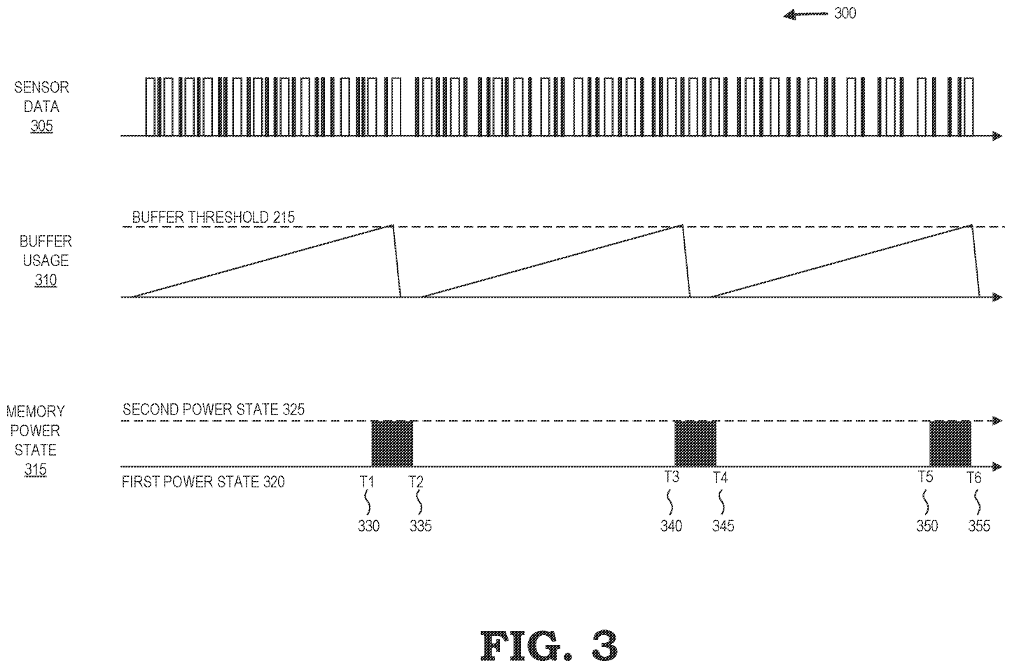

Referring now to FIG. 3, a timing diagram 300 showing buffer usage during a first power state 320 and a second power state 325 is presented, in accordance with implementations. In implementations, timing diagram 300 shows the usage of buffer 128 during example operation 200. For example, during example operation 200, one or more sensors 126 of sensor circuitry 124 are configured to take one or more measurements each representing one or more user interactions with a device, and generate data representative of these measurements, represented in FIG. 3 as sensor data 305. Further, the sensors 126 are configured to store sensor data 305 in buffer 128. As sensor data 305 is stored in buffer 128, the usage of buffer 128 increases (e.g., the percentage of buffer 128 storing sensor data 305 increases) as represented by buffer usage 310 in timing diagram 300.

In implementations, as sensors 126 store sensor data 305 in buffer 128, memory 106 is in a first power state 320, for example, a self-refresh state. While memory 106 is in the first power state 320, memory controller 236 is unable to transfer sensor data 305 from the buffer 128 to memory 106. To this end, sensor data management circuitry 120 is configured to wake memory 106 (e.g., place memory 106 in a second power state 325) based on buffer usage 310. Regarding the example embodiment presented in FIG. 3, based on buffer usage 310 being equal to or greater than buffer threshold 215, sensor data management circuitry 120 first wakes up at least a portion of system management circuitry 116 which, in turn, places at least a portion of memory controller 236, memory 106, or both in the second power state 325 (e.g., a regular power state). As an example, timing diagram 300 includes memory power state 315 representing the power state of memory 106 over time. Within timing diagram 300, at a first time T1 330, buffer usage 310 is equal to or greater than buffer threshold 215. Based on buffer usage 310 being equal to or greater than buffer threshold 215, also at T1 330, sensor data management circuitry 120 wakes memory controller 236, at least a portion memory 106, or both such that the memory power state 315 changes from the first power state 320 to the second power state 325. While memory 106 is in the second power state 325, memory controller 236 is configured to transfer the sensor data stored in buffer 128 to one or more portions of memory 106. Because the sensor data is written from buffer 128 to memory 106, the usage of buffer 128 is reduced as represented by buffer usage 310 between times T1 330 and T2 335. At time T2 335, memory controller 236 completes the process of writing the sensor data from buffer 128 to memory 106. Further, at time T2 335, memory 106 returns to the first power state 320 from the second power state 325.

Additionally, within timing diagram 300, at a third time T3 340 and a fifth time T5 350, buffer usage 310 again is equal to or greater than buffer threshold 215. Due to buffer usage 310 being equal to or greater than buffer threshold 215, at both T3 340 and T5 350, sensor data management circuitry 120 wakes memory controller 236, at least a portion memory 106, or both such that the memory power state 315 changes from the first power state 320 to the second power state 325. After memory controller 236 has finished writing sensor data from buffer 128 to memory 106 at times T4 345 and T6 355, respectively, memory 106 is again placed in the first power state 320. Because memory 106 is only placed in the second power state 325 while memory controller 236 transfers the sensor data from buffer 128, memory 106 is only in a regular power state for a short amount of time, helping reduce the power consumption needed to transfer the sensor data in memory 106.

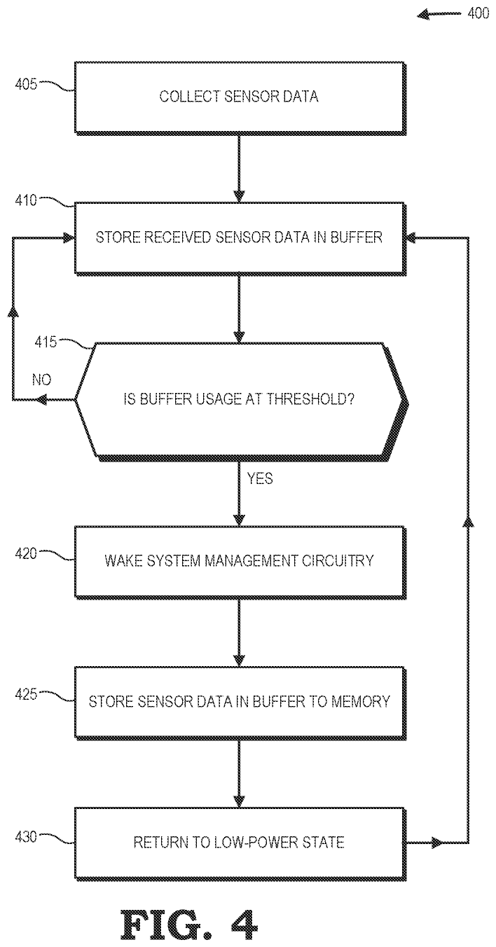

Referring now to FIG. 4, an example method 400 for sensor data collection and storage during a low-power memory state is presented, in accordance with some implementations. According to implementations, at least a portion of example method 400 is implemented by system management circuitry 116, sensor data management circuitry 120, sensor circuitry 124, memory controller 236, or any combination thereof. In implementations, at block 405, one or more sensors 126 of sensor circuitry 124 are configured to take one or more measurements representative of one or more user interactions with a device implementing processing system 100. Such user interactions, for example, include a user handling the device, a user moving the device, a user looking at a camera of the device, a user making noise (e.g., speaking) around the device, or any combination thereof, to name a few. After taking one or more measurements, each sensor 126 is configured to generate sensor data (e.g., sensor data 205, 305) representing the taken measurements. At block 410, each sensor stores generated sensor data in a buffer 128 of sensor circuitry 124. While one or more sensors 126 are storing sensor data in a buffer 128 of sensor circuitry 124, at block 415, sensor data management circuitry 120 is configured to monitor the usage of the buffer 128. That is to say, sensor data management circuitry 120 tracks the percentage of the buffer 128 being used to store sensor data. At block 415, sensor data management circuitry 120 is configured to determine whether the monitored usage of the buffer 128 is equal to or above a buffer threshold 215. Such a buffer threshold 215, for example, includes a predetermined value representing a threshold usage of the buffer 128. Based on the monitored usage being less than the buffer threshold 215, one or more sensors 126 continue to store data in the buffer at block 410, and sensor data management circuitry 120 continues to monitor the usage of the buffer 128.

Based on the monitored usage being equal to or greater than the buffer threshold 215, sensor data management circuitry 120 is configured to wake up at least a portion of system management circuitry 116 at block 420. For example, at block 420, sensor data management circuitry 120 generates a wake-up signal 225 that includes data indicating the sensor data in the buffer 128 is to be transferred to memory 106. Further, in some implementations, wake-up signal 225 includes data that, when received by system management circuitry 116, causes at least a portion of sensor data management circuitry 120 (e.g., a security processor) to exit a low-power state and enter a regular power state (e.g., active state, operational state). At block 425, system management circuitry 116 is configured to wake up memory controller 236, at least a portion of memory 106, or both. That is to say, system management circuitry 116 is configured to place memory controller 236, at least a portion of memory 106, or both in a regular power state. Additionally, in some implementations, system management circuitry 116 is configured to provide a transfer sensor data signal 235 to memory controller 236 that includes data indicating that the sensor data stored in the buffer 128 is to be transferred to one or more certain locations (e.g., physical memory addresses, virtual memory addresses). Still referring to block 425, once memory controller 236, at least a portion of memory 106, or both are in the regular power state, memory controller 236 is configured to transfer the sensor data from the buffer 128 to memory 106. As an example, memory controller 236 transfers the sensor data from buffer 128 in one or more locations of memory 106 indicated by a store sensor data signal 235 received from system management circuitry 116. After memory controller 236 has transferred the sensor data from the buffer 128 to memory 106, at block 430, system management circuitry 116 then places memory controller 236, at least a portion of memory 106, or both back in the low-power state. Once memory controller 236, at least a portion of memory 106, or both return to a low-power state at block 430, the system returns to block 410 where one or more sensors 126 continue to store data in the buffer at block 410 and sensor data management circuitry 120 continues to monitor the usage of the buffer 128.

In some implementations, the apparatus and techniques described above are implemented in a system including one or more integrated circuit (IC) devices (also referred to as integrated circuit packages or microchips), such as the sensor data management circuitry 120 described above with reference to FIGS. 1-4. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processing system, comprising:
a memory;
a buffer configured to store sensor data;
a system management circuitry configured to change at least a portion of the memory from a low-power state to a regular power state based on a usage of the buffer while at least a portion of the memory is in the low-power state; and
a memory controller configured to transfer the sensor data from the buffer to the at least a portion of the memory when the at least a portion of the memory is in the regular power state.

2. The processing system of claim 1, further comprising:
a sensor data management circuitry configured to wake up at least a portion of the system management circuitry based on the usage of the buffer being equal to or greater than a predetermined threshold value.

3. The processing system of claim 2, wherein the system management circuitry is configured to change the at least a portion of the memory from the low-power state to the regular power state in response to receiving a wake-up signal from the sensor data management circuitry.

4. The processing system of claim 2, further including:
a first power rail configured to provide power to the sensor data management circuitry; and
a second power rail configured to provide power to the memory, wherein the first power rail is different from the second power rail.

5. The processing system of claim 1, wherein the system management circuitry is configured to change the memory from the regular power state to the low-power state after the sensor data is transferred to the at least a portion of the memory.

6. The processing system of claim 1, further comprising:
one or more sensors configured to generate the sensor data, wherein the sensor data is representative of one or more user interactions.

7. The processing system of claim 1, wherein at least a portion of the system management circuitry is configured to enter a second low-power state after the memory controller writes the sensor data to the at least a portion of the memory.

8. A method, comprising:
changing, by a system management circuitry, at least a portion of a memory from a low-power state to a regular power state based on a usage of a buffer storing sensor data while the at least a portion of the memory is in the low-power state; and
writing the sensor data from the buffer to the at least a portion of the memory when the at least a portion of the memory is in the regular power state.

9. The method of claim 8, further comprising:
waking up, by a sensor data management circuitry, at least a portion of the system management circuitry based on the usage of the buffer being equal to or greater than a predetermined threshold value.

10. The method of claim 9, wherein the changing the at least a portion of the memory from the low-power state to the regular power state is in response to receiving a wake-up signal from the sensor data management circuitry.

11. The method of claim 10, further comprising:
providing power from a first power rail to the sensor data management circuitry; and
providing power from a second power rail to the memory, wherein the first power rail is different from the second power rail.

12. The method of claim 8, further comprising:
changing the memory from the regular power state to the low-power state after the sensor data is written to the at least a portion of the memory.

13. The method of claim 8, further comprising:
generating, by one or more sensors, the sensor data, wherein the sensor data is representative of one or more user interactions.

14. The method of claim 8, further comprising:
entering, by the system management circuitry, a second low-power state after a memory controller writes the sensor data to the at least a portion of the memory.

15. A processing system, comprising:
a memory;
one or more sensors configured to store sensor data in a buffer; and
a microcontroller configured to:
monitor a usage of the buffer by the sensor data while at least a portion of the memory is in a first power state; and
change the at least a portion of the memory from the first power state to a second power state based on the monitored usage of the buffer.

16. The processing system of claim 15, wherein the microcontroller is configured to:
provide a wake-up signal to a system management circuitry based on the monitored usage of the buffer being equal to or greater than a predetermined threshold value.

17. The processing system of claim 16, wherein the system management circuitry is configured to change the at least a portion of the memory from the first power state to the second power state in response to receiving the wake-up signal.

18. The processing system of claim 16, wherein the system management circuitry is configured to change the memory from the second power state to the first power state after the sensor data has been written to the at least a portion of the memory.

19. The processing system of claim 15, further including:
a first power rail configured to provide power to the microcontroller; and
a second power rail configured to provide power to the memory, wherein the first power rail is different from the second power rail.

20. The processing system of claim 1, wherein the sensor data is representative of one or more user interactions.
